(19) United States
(12) Patent Application Publication
(10) Pub. No.: US 2025/0189691 A1
(43) Pub. Date: Jun. 12, 2025

(54) CAPACITIVE-RESISTIVE IMAGING SYSTEM

(71) Applicant: QinetiQ Limited, Hampshire (GB)

(72) Inventors: Rajinder SINGH, Berkshire (GB); Michael William HOPKINS, Hampshire (GB)

(21) Appl. No.: 18/844,199

(22) PCT Filed: Mar. 9, 2023
(86) PCT No.: PCT/EP2023/056072

§ 371 Date: Sep. 5, 2024

(30) Foreign Application Priority Data
Mar. 11, 2022 (GB) 2203391.4

(51) Int. Cl. G01V 3/20; G01V 3/26

(52) U.S. Cl. CPC G01V 3/20; G01V 3/26

(57) ABSTRACT

A capacitive-resistive imaging system for imaging an environment can include a plurality of conductive electrodes supported on a substrate, and have a side directed away from the substrate, wherein the conductive electrodes are, in use, galvanically isolated from the environment to be imaged, and capacitively couple thereto, and have a dielectric coating on at least the side directed away from the substrate. The dielectric coating advantageously can be higher than 6, and more advantageously is much greater than 6. This encourages an electric field induced into the environment from the electrodes to penetrate further into the environment, and reduces coupling to the substrate. The disclosed subject matter has application in down-hole imaging, monitoring of constructions, foundations, and elsewhere.

### CROSS REFERENCE TO RELATED APPLICATION(S)

This application is a national phase filing under 35 C.F.R. § 371 of and claims priority to PCT Patent Application No. PCT/EP2023/056072, filed on Mar. 9, 2023, which claims the priority benefit under 35 U.S.C. § 119 of British Patent Application No. 2203391.4, filed on Mar. 11, 2022, the contents of each of which are hereby incorporated by reference in their entireties.

This presently disclosed subject matter relates to detection and imaging systems, and more particularly to systems designed to provide information relating to geological conditions surrounding a sensor, as typically used in the oil and gas industries, other wellbore industries, carbon storage and/or transport, geological or other surveying, or other ground or fluid based monitoring applications, and to other imaging applications and environments which lend themselves to electrical resistivity contrast-detection.

Capacitive-resistive imaging (CRI) is known. It is a technique that can be used in measurement of subterranean geological formations and similar, typically (but not exclusively) downhole environments, and also has efficacy in other environments. With this technique, a plurality of conductive electrodes are placed, generally alongside or spaced apart from each other on a plane flat or curved surface such as the side of a tube, and impedance measurements are taken between electrodes to build up a picture of impedances present between the various conductive electrodes. The impedances are influenced by the geological materials surrounding the electrodes, which then are used to infer properties of the materials. An image can be built up by making measurements between different pairs of electrodes, and measurements may be made by making successive measurements at different times or locations, to get a better idea of temporal or spatial changes in the local environment.

A closely related technique is that of resistive imaging, where a galvanic resistance measurement (as opposed to a capacitive measurement) is made between electrodes.

The conductive electrodes are, when used in geological exploration, often mounted to an outer surface of a metal well pipe or the like. The electrodes are insulated from the pipe to prevent the pipe acting as a direct short circuit between them. They also have (when used in capacitive-resistive imaging) an insulated covering protecting them from direct galvanic contact with the surrounding geology. Thus, they are effectively capacitively coupled to their environment.

U.S. Pat. No. 6,809,521 discloses one such system using these techniques. As disclosed therein, a signal is provided to a first electrode, and a differential measurement is made between that electrode and a second electrode positioned nearby. At lower frequencies the capacitance between the electrodes tends to dominate the measurement, manifesting itself as a phase shift between a measured current signal supplied to the first electrode, and a voltage drop between the first and second electrodes. A higher operating frequency is therefore chosen to reduce this effect and instead make the resistance of the material between electrodes the dominant factor in any measurements made. Multiple frequencies may also be used to improve measurements made.

U.S. Pat. No. 6,600,321 discloses a capacitively coupled resistive imaging system for use in borehole investigations. Here, a relatively high operating frequency (of around 1 MHz) is employed to measure the resistivity of formations surrounding the borehole. However, the penetrative range tends to be much diminished with such high frequencies.

The well-known skin-effect, that causes current in a medium to travel more at the edge of the medium as the frequency is increased, also comes into play. Operating a CRI system at increased frequencies acts to reduce the flow of current at distances away from the electrodes, leading to a preference, at least from this aspect, to operate at lower frequencies, however, the current that may be induced to flow in the material is governed by the following equation:

$$I = \frac{2 π fVAk {ε}_{0}}{d} .$$

where V is the supply voltage, A is the plate area, k is the dielectric constant of the insulating material, ε₀ is the permittivity constant of free space, and d is the plate separation. Thus, there is also a desire to increase the operating frequency to increase the current flow.

It has also been found that related art techniques can also have an undesirable capacitive leakage path from the plates to and through a supporting structure which can weaken the received signals.

It is therefore desired to provide an alternative to the related art that overcomes or mitigates problems or issues therewith.

According to a first aspect of the presently disclosed subject matter there is provided a capacitive-resistive imaging system for imaging an environment, the system comprising of a plurality of conductive electrodes positionable in the environment to be imaged, and wherein the conductive electrodes are supported on a substrate, and have a side directed away from the substrate, characterised in that the conductive electrodes are, in use, galvanically isolated from the environment to be imaged, and capacitively couple thereto, and have a dielectric coating on at least the side directed away from the substrate.

The dielectric coating on the electrodes, as per embodiments of the presently disclosed subject matter, helps to propagate current through the material at a greater distance from the substrate. It does this by increasing the capacitance, in the direction away from the substrate, and hence allows lower frequencies of operation to be used, for signals supplied, in use, to the electrodes. Lower frequencies propagate through a given environment at a greater distance than higher frequencies.

The use of dielectric layers for at least a part of the electrode also allows smaller electrodes to be used, to achieve performance, in terms of penetration of current into the environment, at least similar to larger electrodes that are not so coated.

It is well known that the dielectric constant present between the plates of a capacitor affects the value of the capacitance. By increasing the dielectric constant on a part of the electrode that is facing away from the substrate, then it tends to increase the concentration of an electric field between the plates in this area, i.e. in the environment being imaged, rather than towards the substrate.

In many embodiments the substrate will be a metallic pipe, onto which the electrodes are mounted. In such embodiments the environment to be imaged may comprise, for example, a mixture of mud, rock and/or oil or gas deposits. The metallic pipe may be a pipe used, for example, for the extraction of hydrocarbons or minerals from underground or undersea deposits, or for the transportation of captured carbon dioxide to storage reservoirs.

Advantageously, in some embodiments, the dielectric constant of the insulating coating on the side facing away from the substrate is arranged to be greater than 6, 10, 20, 50, 100, 1000, 5000, or 10000. By choosing a material for the insulating coating having a higher dielectric constant, the capacitance between plates can be increased, with the electric field concentrated in the environment being imaged rather than towards the substrate. This provides the benefits in imaging performance as discussed above.

In some embodiments the conductive electrodes may have a coating having a higher dielectric constant on the side facing away from the substrate, as compared to a side or other region facing towards the substrate. This again helps to direct an electric field present between two electrodes away from the substrate and into the environment being imaged.

Advantageously, in some embodiments, the insulating coating on the electrode, on parts thereof facing towards the substrate, or are positioned between the electrode and the substrate, has a dielectric constant of less than 6, and may in some embodiments be as less than 5.

Advantageously, in some embodiments, the insulating coating on the electrode, or on parts thereof facing towards the substrate, or positioned between the electrode and the substrate, has a larger surface area than that of the electrode. In such embodiments the insulating coating between the electrode and the substrate extends beyond the area of the plate so as to provide an extended insulating barrier between the electrode and the substrate.

Advantageously, in some embodiments, the insulating coating applied to the side of the electrode facing away from the substrate is a different material from insulation used elsewhere on the electrode.

In some embodiments the dielectric coating on parts thereof facing towards the substrate, or positioned between the electrode and the substrate, has a thickness that is equal to, or greater than, the coating thickness on a side or region facing away from the substrate. Thus, in such embodiments, the coating has a thickness on a side facing away from the substrate that is equal to, or less than, the coating thickness on a side or region facing towards the substrate. This is because a thinner coating allows better current flow into the environment than a thicker coating, with other factors being equal.

It will be appreciated that a thickness d of insulating material applied to the electrode is kept as thin as practicable, bearing in mind conflicting requirements of voltage breakdown, strength and durability leading to a thicker coating, and a value of capacitance between electrodes on a system also being dependent on the thickness, due to the formula C=A∈ᵣ∈/d, where A is the effective electrode area, and ∈ and ∈ᵣ are the absolute and relative permittivities respectively of the material separating the plates, which of course includes the insulating material. It is desired to keep the capacitance high, so leading to a preference for lower value of d, and a higher value of ∈. The breakdown voltage of the material, which is inversely dependent on d, should also be taken into account, which, similarly to the durability issue, pressures the designer to use thicker layers.

In some embodiments the thickness of the insulating material may be chosen to be approximately 0.2 mm, 0.5 mm, 1 mm 2 mm or 5 mm thick, although other embodiments may go beyond this.

The insulating, dielectric coating on the electrode on regions thereof facing away from the substrate may be chosen from any suitable material. These may include Neoprene, Tantalum Pentoxide, Strontium Titanate, Barium Titanate and Calcium Copper Titanate, or some other material.

In some embodiments, an electrode may be made up from a plurality of smaller sub-electrodes, all electrically coupled together and arranged adjacent each other. Thus, electrodes made in this manner will act electrically as a single electrode, but it has been found that it can be easier to provide an insulating coating on the smaller, sub-electrodes, thus providing each sub-electrode with its own insulating coating. It therefore can have manufacturing benefits, whilst still allowing for large electrodes to be made.

In some embodiments an electrode (or sub-electrode, if made from a plurality of sub-electrodes) may comprise a first conductive metallic layer, and attached to the electrode is a dielectric material having a dielectric of greater than 6, whilst attached to an opposing side of the dielectric material is a further conductive plate, which is thus capacitively coupled to the first conductive metallic layer. The further conductive plate is arranged, in use, to be in direct contact with the environment in which the system is to be used.

In some embodiments, an electrode (or sub-electrode, if made from a plurality of sub-electrodes) may comprise a metallic layer having a surface arranged to face away from the substrate, an array of capacitors thereon, wherein each capacitor has two terminals, and is attached to the metallic layer at one terminal, and is attached to a further conductive plate at its second terminal. Thus, in such an arrangement, the array of capacitors are effectively connected in parallel between the surface of the metallic layer, which is connected by a cable to a signal generator or receiver, and the conductive plate (which is in contact with the environment being imaged, in use), and provide galvanic isolation between the electrode and the conductive plate and environment beyond. Each capacitor has a dielectric therein, having a dielectric constant of at least 6, and in general will be very much higher.

Thus, in such embodiments, the capacitors at least partially provide the dielectric coating to the electrode, and have the conductive plate thereon to give a low impedance interface between the electrode and the environment beyond. The capacitors may be Commercial, Off-The-Shelf (COTS) capacitors.

In some embodiments an electrode (or sub-electrode) may have a protective coating, covering some or all of the insulation material. The protective coating may comprise a metal foam, a ceramic material, a metal particulate layer, or a conductive fibre, or some other material. The protective coating may be used to promote electrical coupling to the environment to be image, and/or may be use to aid with environmental protection of the electrode, either during installation, or use of the imaging system. In embodiments where an array of discrete capacitors are used as the dielectric layer, the capacitors may connect to this protective coating, where the coating is conductive.

Some embodiments may further comprise a plurality of transmit electrodes, that are connected to a signal source, and a plurality of receive electrodes, that are connected to a signal detector.

### BRIEF DESCRIPTION OF THE DRAWINGS

The presently disclosed subject matter will now be described, by way of example only, with reference to the following Figures, of which:

FIG. 1 diagrammatically illustrates the basic concept of capacitive resistive imaging;

FIG. 2 diagrammatically illustrates an embodiment of the presently disclosed subject matter;

FIG. 3 diagrammatically illustrates another embodiment of the presently disclosed subject matter, showing an electrode with a dielectric layer provided at least in part by an array of capacitors;

FIG. 4 diagrammatically illustrates another embodiment of the presently disclosed subject matter, wherein the electrode is mounted to an oversized insulator of low dielectric constant;

FIG. 5 diagrammatically illustrates a further embodiment of the presently disclosed subject matter, wherein the electrode has a conductive layer present as its outermost layer, for providing a good conductive connection to an environment in which it is operated; and

FIG. 6 diagrammatically illustrates a further embodiment of the presently disclosed subject matter, wherein an electrode comprises of an array of sub-electrodes.

### DETAILED DESCRIPTION

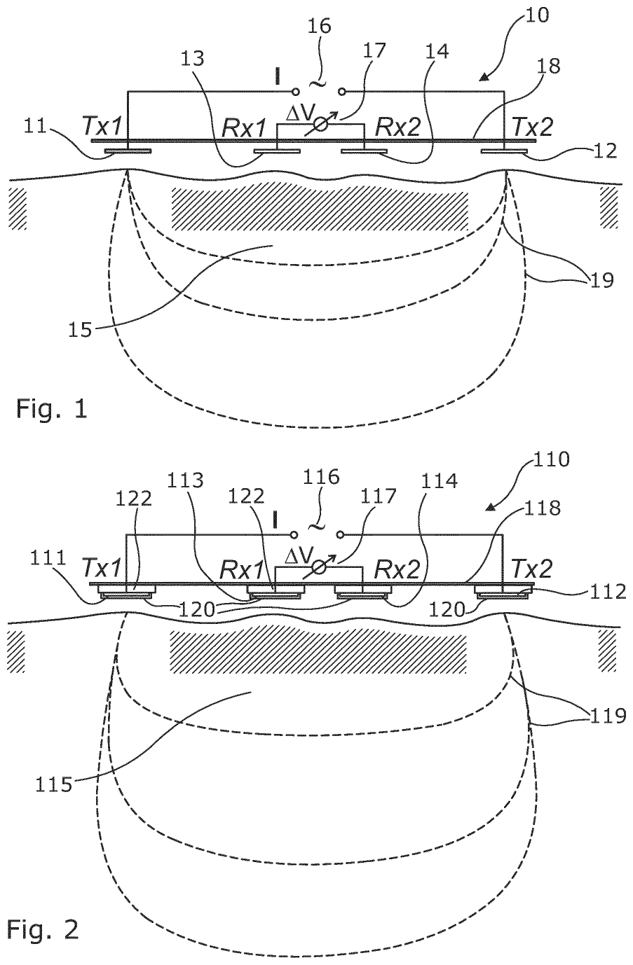

FIG. 1 shows a simplified application of capacitive resistive imaging. Here, an imaging system 10 has two transmitter electrodes 11, 12 and two receive electrodes 13, 14 that are capacitively coupled to surrounding medium 15 (such as geology or water). The electrodes 11-14 are mounted on a metallic substrate 18 for structural support. A signal generator 16 supplies a signal to the transmitter electrodes 11, 12, driving the two in anti-phase, so as to maximise a voltage potential between them. The frequency of the signal used typically varies from the low kHz up to the low MHz, but can go outside of these values, particularly when long range operation is required, where the frequency of operation may go down as low as 1 to 10 Hz. This generates an electric field 19 in the medium 15. A signal detector 17 is connected to the receive electrodes 13, 14 and measures a potential difference between each one and the substrate 18 to detect changes in the electric field 19. This known technique can be used for detection of objects or targets, as an object located in the surrounding medium would cause a disturbance to the electrical field created by the transmitter electrodes, which would then be detected by the receiver electrodes and the signal detector attached thereto.

FIG. 2 shows an embodiment of the presently disclosed subject matter. It comprises of generally like elements to those of FIG. 1, and similar elements have the same reference numbers but increased by 100. The difference between this and the system of FIG. 1 is the electrodes 112 now each have a coating of a dielectric material 120 on a side thereof opposite to that of the substrate 118. The dielectric material acts to increase the capacitance between electrodes. This increase in capacitance has the effect of decreasing the impedance, so increasing the current flow at a given operating frequency, with the increased current flow occurring generally from the regions of the electrode where the dielectric constant is greater. This is shown in FIG. 2 indicatively, with field lines 119 extending further out than when related art electrodes are used, with other things, such as frequency of operation and drive current to the electrodes, being equal. Thus, the operating frequency may be reduced, whilst maintaining a current flow equivalent to that which would be achieved at a greater operating frequency. This reduced operating frequency has the effect of increasing the distance out from the electrodes, at which the field lines pass, so increasing the distance from the electrodes at which the environment may be imaged. It can be seen then that by increasing the capacitance according to embodiments of the presently disclosed subject matter, the imaging capability can be improved, either by increasing current flowing in the environment at a given frequency, or by lowering the frequency whilst maintaining a higher current that would otherwise be available (with other factors such as the size of the electrodes remaining equal).

There is a layer of dielectric material 122 on the side of the electrode, with this material being different to the material 120 on the side facing away from the substrate 118, wherein the material 122 has a lower dielectric constant than the material 120. The material 122 is also arranged to be larger in extent than the electrodes 112, with an overlap of the material 122 around each electrode. This helps again to reduce field lines short-circuiting to the substrate.

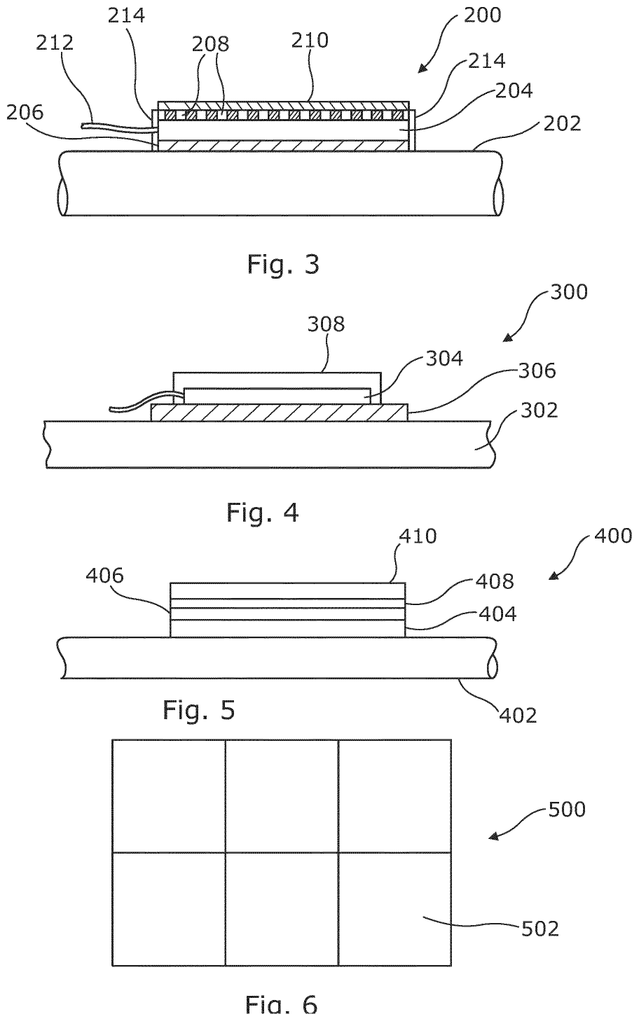

FIG. 3 shows (not to scale) a detail, cross-section view of an electrode forming part of an embodiment of the presently disclosed subject matter, mounted on a substrate. The electrode 200 is mounted on a metal pipe 202, which comprises the substrate. The electrode has a metal conductive plate 204 that sits on a low dielectric insulator 206, the dielectric constant of which is less than 6. On an outward (with respect to the substrate) face of the conductive plate 204 are mounted, by soldering, welding, or some other means allowing current flow, first terminals of a plurality of capacitors 208, all connected in parallel, with the second terminals of each capacitor being connected to a cover plate 210. The capacitors are chosen which have a dielectric material having a dielectric constant greater than 6. Thus, the dielectric present in the capacitors acts at least partially as the dielectric coating for the electrode.

The conductive plate 204 is connected to a cable 212 which goes either to an output of a signal source (if the electrode is a transmit electrode), or to an input of a sensor amplifier (if the electrode is a receive electrode). Insulating material around the edge of the conductive plate 204 prevents a galvanic connection between the plate 204 and the surrounding environment.

The cover plate 210 is a conductive plate, which may comprise of a metal foam, or a metal plate, or other conductive material. The cover plate helps to provide good connection to the surrounding environment, with the capacitors providing both a galvanic isolation between the conductive plate 204 and the environment, and also acting, due to the relatively high dielectric material used therein, to direct the electric field outwards into the environment.

FIG. 4 shows a further electrode arrangement 300 for use in an embodiment of the presently disclosed subject matter, again in cross-sectional form. Mounted on substrate 302, it comprises of a metal electrode 304, and low-dielectric insulator 306, which separates the electrode 304 from the substrate. Covering the electrode 304 on a side facing away from the substrate is a high-dielectric insulator 308. The insulator 308 also covers the sides of the electrode 302, so as to give galvanic isolation between it and whatever environment is present surrounding the electrode 304. The low dielectric insulator 306 is larger than the electrode 304, and so presents a further barrier for energy to pass from the electrode 304 to the substrate 302, which is typically a metal object, such as a metal pipe.

FIG. 5 shows a further electrode arrangement 400, for use in some embodiments of the presently disclosed subject matter. A substrate 402 has mounted thereon a CRI electrode having a sandwich structure, comprising an insulator 404 having a low dielectric constant, of less than 6. On the insulator 404 is the electrode itself, 406, comprising a metal plate. The metal plate is galvanically isolated from the environment in which the electrode is deployed. There is a cable (not shown) for supplying a drive signal to the electrode when used as a transmit electrode, and for conducting received currents to a signal processor/conditioner, when used as a receive electrode On the electrode 406 sits a high dielectric material 408, having a dielectric constant greater than 6. On the high dielectric material sits a protective layer 410 that comprises of a conductive material. This may be, in different embodiments, a metal foam layer, a metal particulate layer, or a conductive fibre layer, or any other conductive material. The conductivity may be tailored to match that expected in whatever environment the electrode is to be deployed.

As well as providing physical protection to the layers beneath it, the protective layer 410 helps to propagate the current, capacitively coupled from the electrode 406, into the environment.

FIG. 6 shows a further embodiment of the presently disclosed subject matter, employing electrodes that are each divided into sub-electrodes. The figure shows a single such electrode 500, that is comprised of six sub-electrodes, e.g. 502, in a 2×3 array. Each sub-electrode comprises of its own conductive layer and high dielectric insulator covering a face external to (i.e. not facing) that of the substrate on which the electrode is mounted. This allows high dielectric coatings to be applied onto smaller electrodes for ease of manufacture, whilst also giving the higher performance of a single, large electrode equivalent in size to that of the combined sub-electrode sizes.

The sub-electrodes are butted together at the edges to form a functionally single electrode, as far as electrical performance is concerned. The sub-electrodes are all connected to a single cable for the purposes of either driving the electrode in transmit, or providing received signals to a signal conditioner/processor, in receive. The sub-electrodes may have a further protective coating, in similar fashion to that shown in relation to FIG. 5, either applied individually to each sub-electrode, or collectively to all the sub-electrodes that are used in a single electrode.

Although shown as a generally horizontal structure in the above figures, the embodiment may also, and in general typically is, used in a vertical manner, with the substrate comprising a pipe in a wellbore or similar, with the electrodes being mounted thereon. Also, although described generally as plates, the electrodes may be shaped as required for a particular installation. In many instances, the electrodes will be curved to match the curvature of a pipe to which they are mounted. Note that the figures are not drawn to scale.

Table 1 shows the results of tests done in laboratory conditions of plates with two different coating materials. The first material used was an acetate plastic, having a dielectric constant of 3, and measurements were taken between two plates having this coating. The second test used a Neoprene coating on two plates, having a dielectric constant of 6.7, and again measurements taken between the plates.

Voltages and currents measured at a similar distance from the plates for each test are provided in the Table, with the values of the voltages and currents being normalised to account for the relative thicknesses of the coating materials used. It can be seen that the normalised values for the voltage and current obtained with the neoprene are significantly higher than with the acetate coating.

TABLE 1

| Coating material | Acetate plastic | Neoprene |
|---|---|---|
| Thickness | 0.125 mm | 1.5 mm |
| Dielectric constant | 3 | 6.7 |
| Normalised voltage | 66.06 mV | 126.24 mV |
| (with respect to | | |
| acetate thickness) | | |
| Normalised current | 6.61 mA | 12.60 mA |
| (with respect to | | |
| acetate thickness) | | |

Although the presently disclosed subject matter has been described mainly for the application of down-hole imaging, it also has application in other imaging environments, such as in water, or in metallurgical or engineering applications, such as for the monitoring of metalwork, concrete constructions or foundations etc.

It will be appreciated by the person skilled in the art that features in one aspect of the presently disclosed subject matter may be applied to other aspects of the presently disclosed subject matter, in any appropriate combination. In particular, method aspects may be applied to apparatus aspects, and vice-versa, and elements present in one embodiment may be used in other embodiments, where there is no technical conflict. It will further be understood that the various embodiments disclosed herein have been described for the purposes of illustration, and that modifications may be made without departing from the scope of the present disclosure.

1. A capacitive-resistive imaging system for imaging an environment, the system comprising of a plurality of conductive electrodes positionable in the environment to be imaged, and wherein the conductive electrodes are supported on a substrate, and have a side directed away from the substrate, wherein the conductive electrodes are, in use, galvanically isolated from the environment to be imaged, and capacitively couple thereto, and have a dielectric coating on at least the side directed away from the substrate.

2. An imaging system as claimed in claim 1 wherein the dielectric constant of the dielectric coating on the side facing away from the substrate is greater than 6.

3. An imaging system as claimed in claim 2 wherein the conductive electrodes have a dielectric coating having a higher dielectric constant on the side facing away from the substrate, as compared to a side or other region facing towards the substrate.

4. An imaging system as claimed in claim 1 wherein the dielectric coating, on the electrode, on parts thereof facing towards the substrate, or positioned between the electrode and the substrate, has a has a dielectric constant of less than 6, or less than 5.

5. An imaging system as claimed in claim 4 wherein the dielectric coating on the electrode, or on parts thereof facing towards the substrate, or positioned between the electrode and the substrate, has a larger surface area than that of the electrode.

6. An imaging system as claimed in claim 1 wherein the dielectric coating applied to the side of the electrode facing away from the substrate is a different material from insulation used elsewhere on the electrode.

7. An imaging system as claimed in claim 1 wherein the dielectric coating on parts thereof facing towards the substrate, or positioned between the electrode and the substrate, has a thickness that is equal to, or greater than, a dielectric coating thickness on a side or region facing away from the substrate.

8. An imaging system as claimed in claim 1 wherein the dielectric coating on the electrode on regions thereof facing away from the substrate is chosen from Neoprene, Tantalum Pentoxide, Strontium Titanate, Barium Titanate and Calcium Copper Titanate.

9. An imaging system as claimed in claim 1 wherein an electrode is made up from a plurality of smaller sub-electrodes, all electrically coupled together and arranged adjacent each other.

10. An imaging system as claimed in claim 9 wherein each sub-electrode has its own insulation coating thereon.

11. An imaging system as claimed in claim 1 wherein a further conductive plate is attached to the dielectric material, the further conductive plate being arranged, in use, to be in direct contact with the environment in which the system is to be used.

12. An imaging system as claimed in claim 11 wherein the dielectric coating on the side facing away from the substrate is formed, at least in part, by dielectric material within a plurality of capacitors, each arranged in parallel and having two terminals, wherein a first terminal of each capacitor is connected to the conductive electrode, and a second terminal thereof is connected to the further conductive plate.

13. An imaging system as claimed in claim 1 wherein the system comprises of a plurality of transmit electrodes, that are connected to a signal source, and a plurality of receive electrodes, that are connected to a signal detector.

14. An imaging system as claimed in claim 1 wherein the dielectric constant of the dielectric coating on the side facing away from the substrate is greater than 10.

15. An imaging system as claimed in claim 1 wherein the dielectric constant of the dielectric coating on the side facing away from the substrate is greater than 20.

16. An imaging system as claimed in claim 1 wherein the dielectric constant of the dielectric coating on the side facing away from the substrate is greater than 50.

17. An imaging system as claimed in claim 1 wherein the dielectric constant of the dielectric coating on the side facing away from the substrate is greater than 100.

18. An imaging system as claimed in claim 1 wherein the dielectric coating, on the electrode, on parts thereof facing towards the substrate, or positioned between the electrode and the substrate, has a has a dielectric constant of less than 5.
